(19) United States
(12) Patent Application Publication
(10) Pub. No.: US 2026/0014747 A1
(43) Pub. Date: Jan. 15, 2026

(54) TEMPERING SYSTEM FOR TEMPERING COMPONENTS OF MANUFACTURING CELLS

(71) Applicant: ENGEL AUSTRIA GmbH, Schwertberg (AT)

(72) Inventors: Mathias SCHLAEGER, Hagenberg im Muehlkreis (AT); Karlheinz MAYR, Schwertberg (AT)

(21) Appl. No.: 19/262,611

(22) Filed: Jul. 8, 2025

(30) Foreign Application Priority Data
Jul. 9, 2024 (AT) A 50560/2024

(51) Int. Cl. B29C 45/78

(52) U.S. Cl. CPC B29C 45/78; B29C 2945/76531; B29C 2945/76732

(57) ABSTRACT

A temperature control system for controlling the temperature of components, in particular molds, of production cells, includes at least one centrally supplyable temperature control device assigned to at least one production cell, a central control or regulating unit, and optionally at least one conveying device for supplying the temperature control devices with a temperature control medium. The central control or regulating unit is configured to control the respective at least one temperature control device and optionally the at least one conveying device by control commands. The central control or regulating unit is configured to at least partially compensate for a subsequent change in operating states of the temperature control devices assigned to the other production cells caused thereby by changing the control commands when changing and/or in case of a change of an operating state of at least one production cell.

### BACKGROUND OF THE INVENTION

The present invention relates to a temperature control system for temperature control of components, in particular molds, of production cells and to a method for operating such a temperature control system. Molds used in molding machines such as injection molding machines, injection presses, presses and the like often need their temperature to be controlled, i.e. cooled or heated in a targeted manner. In the following, the prior art shall be outlined in the case of a mold of an injection molding machine. Generalities apply to components of production cells.

The temperature control of a mold can be achieved by conveying temperature control media through corresponding temperature control channels that pass through the mold. In many cases, multiple temperature control channels are used and it is known to regulate the temperature control medium volume flow through the individual temperature control channels by adjusting the volume flow, the pressure gradient or the temperature difference. For this purpose, the individual temperature control channels are usually equipped with throttle valves or other control elements.

Corresponding regulation systems can be found, for example, in DE 10 2016 011 873 A1 or EP 3 309 402 A1.

For example, corresponding injection molding machines or general forming machines are often integrated into production cells, with additional devices cooperating with the injection molding machine being provided, which may also require temperature control, such as preheating of insert components or post-treatment of the produced components.

Since such production cells usually do not stand alone, but several production cells are arranged in a hall of a production site, it is known from the prior art to implement temperature control systems which are designed to supply several production cells, wherein the temperature control system supplies several production cells with a temperature control medium which is distributed between the production cells.

Generic temperature control systems for temperature control of components of production cells each comprise at least one centrally supplied temperature control device assigned to at least one production cell and optionally at least one conveying device for supplying the temperature control devices with a temperature control medium.

During operation, each of the production cells or the temperature control devices of the production cells are centrally supplied with a temperature control medium via at least one conveying device.

However, it has been found that the disadvantage of such a system is that it has little flexibility with regard to changes in the operating conditions of the individual production cells.

Thus, a change in the operating status of one production cell has a direct impact on all other production cells (in this terminology: subsequent changes). For example, if one production cell is switched off, the remaining production cells are exposed to a higher partial volume flow if the conveying device provides a constant flow rate. Conversely, a lower partial volume flow at the production cells can of course also occur if a production cell is switched on. Such changes in temperature control can lead to rejected parts, as the production cells are heated or cooled too much during operation.

### SUMMARY OF THE INVENTION

The object of the present invention is to provide a temperature control system for temperature control of components of production cells and a method for operating such a temperature control system, with which the previously described disadvantages of the prior art can be at least partially improved and/or a more individual temperature control of production cells can be implemented despite central supply and/or with which a more dynamic operational adjustment can be carried out during the ongoing operation of several production cells despite central supply of several production cells and/or with which the occurrence of rejected parts can be reduced.

This object is achieved according to the invention by a temperature control system for temperature control of components, in particular molds of production cells, as described herein, a method for operating a temperature control system for temperature control of components of production cells as described herein, a use of such a temperature control system in such a method, a computer program product as described herein, a computer-readable transitory or non-transitory data carrier, and a data carrier signal as described herein.

According to the invention, a temperature control system for temperature control of components, in particular molds of production cells, comprises in each case at least one centrally supplied temperature control device assigned to at least one production cell and a central control or regulating unit and optionally at least one conveying device for supplying the temperature control devices with a temperature control medium. The central control or regulating unit is designed to control in each case the at least one temperature control device and optionally the at least one conveying device by means of control commands. The control or regulating unit is designed to at least partially compensate for a subsequent change in the operating states of the temperature control devices assigned to the other production cells by changing the control commands when changing and/or when an operating state of at least one production cell is changed.

The central control or regulation unit thus creates the possibility of taking into account influences that affect the respective production cells and their temperature control across all production cells that are connected to the temperature control system via the respective temperature control devices and of compensating them automatically or semi-automatically.

Thus, for example, the central control or regulation unit can detect when a change in the operating status of a production site occurs or is imminent, which has a direct impact on the other production cells. A higher or lower total flow rate or pressure in the inlet can, for example, be used to compensate for these effects.

In general terms, by detecting the change in the operating state by the central control or regulating unit, it is possible to immediately counteract or compensate for a subsequent change by changing the control commands of the temperature control devices of the other production cells and/or of the at least one conveying device.

A similar approach can be taken when planning to change the operating state of a production cell. For this purpose, it is not necessary to wait for the change in the operating state to be detected, but compensation can preferably be carried out within the framework of predictive control and/or feedforward control.

A change in an operating state does not necessarily mean the shutdown or commissioning of at least one production cell. Any variation or change in at least one production cell can be considered a change in the operating state, which manifests itself as a subsequent change, particularly in the temperature control of the other production cells.

For example, a change in the energy requirement of one production cell (preferably a reduction in the coolant requirement of a production cell due to an increase in the cycle time or decreasing ambient temperatures) can also have a direct effect on the other production cells, since if the temperature control system remains constant, the energy requirement not required by at least one production cell is redistributed to the other production cells. Changes in at least one production cell with regard to the ambient temperature, productivity, production speed, material processed or aging of the production cell can also result in subsequent changes in the other production cells.

A change in an operating state can occur actively through manual or semi-automated changes to the production cell (e.g. a parameter change on an injection molding machine) or passively through automatic or error-related changes to the operating condition (e.g. through automatic shutdown following a malfunction of the production cell). Corresponding components of production cells can be, for example, molds. Molds are used by molding machines such as injection molding machines, injection presses, presses and the like.

Control commands for controlling at least one temperature control device and/or the at least one conveying device can be designed to control, regulate or change settings of these components. For example, the control commands can be reference values for open-loop or closed-loop control systems and/or controller gains and/or parameters of model-based open-loop or closed-loop control systems.

Production cells may preferably consist of a forming machine, a mold mounted thereon, and other equipment and components that are necessary or advantageous for the intended production of the molded parts. Of course, at least one temperature control device is part of the production cell to which it is assigned.

The at least one conveying device can be provided and/or configured for the central supply of the temperature control devices.

A central supply of the temperature control system can be achieved, for example, by a central cooling system, a central temperature control device, a central cooling device, a central heating device, a central heat exchanger or the central addition of cold or warm temperature control medium.

The central control or regulating unit is central in the sense that it is designed to output the control commands to the temperature control devices and optionally to the at least one conveying device. Physically, the control or regulation unit can be implemented as a separate computer at the production site or as a cloud server. Another alternative would be for the control or regulation unit to be integrated into a machine control system of a forming machine or a temperature control device. The control or regulation unit can also be realized by combinations of the mentioned possibilities and/or distributed computing.

The same applies to control or regulation devices of the individual temperature control devices.

The temperature control devices can be integrated into the forming machine and/or the forming tool. Alternatively or additionally, separate temperature control devices can be used.

In terms of terminology, a distinction is made in this document between actively changing the operating state of a production cell, which includes, for example, switching a production cell off and/or on and/or reducing and/or increasing the production activity of a production cell (for example in a predetermined time sequence). Passive changes in an operating state occur, for example, due to changing environmental influences, such as changes in the ambient temperature and/or the flow temperature due to the time of day or weather. Further examples would be a pressure change at a temperature control medium source or machine damage.

The changed operating state can then consist, for example, in temperatures of the mold that are too high or too low or volume flows in temperature control channels that are too low or too high, which are undesirable from the point of view of energy efficiency and/or temperature distribution, for example.

Compensation of subsequent changes in operating conditions is preferably carried out completely. In practice, however, scenarios are also conceivable in which the compensation cannot be carried out perfectly, for example because there is not enough flow capacity or because a certain period of time is required during adjustment until a (quasi-) stationary state is reached again.

Only partial compensation may also be desired in order to achieve a system that is as robust as possible against failures, wherein a certain rejection rate is accepted to achieve this goal. For example, a certain number of operating conditions could be declared as acceptable for a temperature control device and then only the compensation could be carried out in such a way that the range of acceptable operating conditions is not abandoned.

The measures and features mentioned in connection with the prior art can also be provided within the scope of the invention.

The computer executing the computer program can be the central control or regulation unit of the temperature control system.

The computer program product can trigger and/or start and/or continue the compensation of the subsequent changes if the computer program product actively operates a change in the operating state and/or if the executing computer receives signals, for example from control and/or regulating devices of the production cells, as input that indicate a change in the operating state.

Changing the operating state can be understood as actively taking an action which results in a changed operating state. A change in the operating state can be understood as the receipt of signals that indicate a changed operating state.

The statements contained herein with regard to the central control and/or regulating device also apply mutatis mutandis to the computer program product.

At least one temperature control device assigned to the production cells can have a control or regulating device, which control or regulating device is connected to the central control or regulating unit in a signal-conducting manner, and the control or regulating device is designed to control or regulate the temperature control of the respective production cells, preferably locally.

For example, the control or regulating device assigned to the at least one temperature control device can be designed, by the signal-conducting connection to the control or regulating unit, to forward all or part of the information regarding the system of the temperature control device, the control commands, the regulating commands, and the settings of the temperature control device to the control or regulating unit.

The control or regulating unit can be designed to monitor, diagnose and/or analyze the respectively assigned temperature control unit on the basis of the transmitted signals of the control or regulating device.

Preferably, the control or regulating unit is designed to transmit signals to the control or regulating device via the signal-conducting connection, which signals directly cause the control or regulating device to carry out an adjustment, regulation or control of the associated temperature control device.

The control or regulating unit can be designed to output control commands to the other control or regulating devices of the other production cells in the event of a change in the operating state of one of the production cells, and the control or regulating devices can be designed to implement these control commands at the respective temperature control device.

Preferably, at least one, preferably all, of the temperature control devices have at least one sensor, preferably connected to the control or regulating unit in a signal-conducting manner, which sensor is designed to detect a characteristic signal for an operating state of the respective production cell. This signal connection can be direct or indirect, for example via the corresponding control or regulating device.

A corresponding sensor may, for example, comprise a temperature sensor, a pressure sensor, a flow sensor, a volume flow sensor, a sensor for measuring heat flow, a sensor element for measuring temperature differences, and/or a combination of these.

The control or regulating unit can be designed to detect a change in the operating state of the associated production cell and/or to monitor the operating state of the associated production cell by means of signals transmitted from the control or regulating device and/or the sensor.

Preferably, the control or regulating unit is designed to change the control commands of the temperature control device of the other production cells and/or the conveying device in the event of a change in the operating state of the associated production cell, preferably in terms of amount, greater than a predefined limit value.

The at least one conveying device which can be controlled by the central control or regulating unit can be designed to provide a temperature control medium fed into a central feed channel for the at least one temperature control device assigned to the production cells.

Preferably, the control or regulating unit is designed to output control commands corresponding to the production cells to the at least one conveying device in the event of a change in an operating state. The control or regulating device is designed to adapt a conveying capacity of the at least one conveying device of the temperature control system to the change in the operating condition.

For example, when one of the production cells is taken out of active operation (switched off), the control or regulating unit can detect this and, by controlling the conveyor device, reduce the conveying capacity of the conveyor device accordingly by the amount that was previously required by the correspondingly switched off production cell, so that the switching off of the production cell has no effect on the other production cells or has a reduced effect.

The at least one temperature control device assigned to the production cells can be connected to at least one central supply channel and at least one central discharge channel of the temperature control system. A temperature control medium is provided to the temperature control devices via the central supply channel and is discharged via the central discharge channel.

Preferably, at least one, preferably all, of the at least one temperature control device assigned to the production cells has a throttle device which is connected to the control or regulating unit and/or the control or regulating device in a signal-conducting manner and which is designed to adapt a temperature control by varying the volume flow of the temperature control medium.

The control or regulating unit can be designed to output a control command to the throttle devices correspondingly assigned to the other production cells when the operating state of a production cell changes. This can happen directly or indirectly, for example by the corresponding control or regulating device.

Preferably, the control or regulating unit can be designed to reduce a conveying capacity of the at least one conveying device and/or to reduce a volume flow through the temperature control devices of the other production cells in the event of a change in an operating state of the production cells which leads to a reduced energy requirement for temperature control the associated production cell, in particular to a shutdown of the associated production cell. A reduced need for temperature control of a production cell can be due, for example, to a shutdown of the production cell, a slowdown in production (in particular a reduction in cycle time), a temperature fluctuation in the environment or another environmental influence.

The control or regulating unit can be designed to increase a conveying capacity of the at least one conveying device and/or to increase a volume flow through the temperature control device of the other production cells and/or to emit a warning signal and/or to adapt the operating conditions of the other production cells, in particular by the control or regulating devices, in the event of a change in the operating state of one of the production cells which leads to an increased need for temperature control of the associated production cell. A warning signal can be issued, for example, when the system limits of the temperature control system are reached, at which a required temperature control medium quantity and/or a required temperature control medium volume flow can no longer be provided by the conveying device.

A prioritization (for example based on the components produced by the individual production cells) can be stored in the control or regulation unit. Such prioritization can, for example, cause the control or regulating unit to adjust the operating state of the production cell or cells with the lowest priority in such a way that they reduce their productivity or are even switched off in favor of the production cells with a higher priority if the temperature control requirement of the production cells exceeds the system limits.

In a simple example, the control or regulating unit can thus be designed so that if, due to changing operating conditions, the temperature control system can no longer meet the required temperature control performance (can no longer provide the required temperature control medium quantity), the production cells with a high priority continue to be supplied with the required temperature control medium quantity via the prioritization stored in the control or regulating unit, whereas the production cells with a lower priority have their productivity slowed down or are even switched off in order to continue to operate the production cells with the high priority without being affected.

Furthermore, protection is sought for a method for operating a temperature control system for temperature control of components, preferably molds of production cells, in particular temperature control systems according to the invention. At least one centrally supplied temperature control device assigned to at least one production cell is used, and optionally the temperature control devices are supplied with a temperature control medium by at least one conveying device. When changing or when an operating state of at least one production cell is changed, a resulting subsequent change in operating states of the temperature control devices assigned to the other production cells is at least partially compensated for by changing settings and/or control commands of the temperature control devices and optionally of the at least one conveying device.

In certain embodiments, the temperature control in a production cell can be variothermal. This means that in a first part of a production cycle, the temperature control can consist of heating a mold (for example, to create optimal conditions for the injection process) and in a second part of the production cycle, the temperature control can consist of cooling the mold (for example, to achieve the fastest possible cooling and/or solidification of the molded part and thus the shortest possible cycle time).

Protection is also sought for a computer program product comprising commands which cause a computer executing the computer program product to control at least one temperature control device of production cells and optionally at least one conveying device by issuing control commands. The commands also cause the executing computer, when changing and/or when an operating state of at least one production cell is changed, to at least partially compensate for a resulting subsequent change in the operating states of the temperature control devices assigned to the other production cells by changing the control commands.

Furthermore, protection is sought for a computer-readable transitory or non-transitory data carrier on which a computer program product according to the invention is stored.

Protection is also sought for a data carrier signal which contains control commands which have the function of at least partially compensating for a subsequent change in the operating states of other temperature control devices assigned to the production cells when changing and/or when an operating state of at least one production cell is changed.

### BRIEF DESCRIPTION OF THE DRAWINGS

Further advantages and details of the invention will be apparent from the drawings and the associated description of the drawings, in which:

FIG. 1 shows a first exemplary embodiment of a temperature control system according to the invention,

FIG. 2 shows a second exemplary embodiment of a temperature control system according to the invention, and

FIGS. 3 and 4 show two different embodiments of production cells.

### DETAILED DESCRIPTION OF THE INVENTION

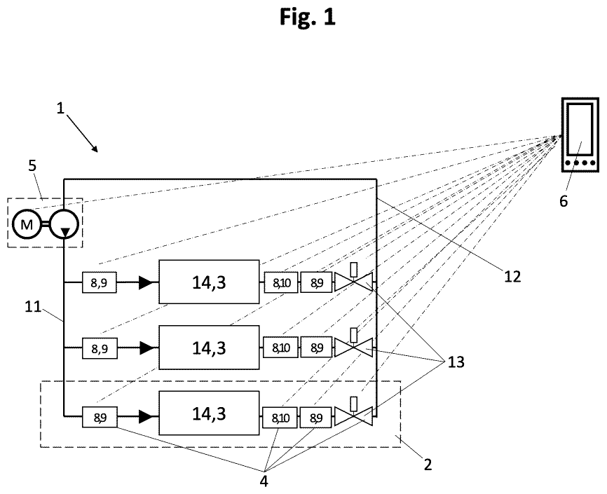

FIG. 1 shows a first exemplary embodiment of a temperature control system 1 according to the invention. In this embodiment, the temperature control system 1 comprises a central conveying device 5 consisting of a drive motor and a conveying pump.

This conveying device 5 is designed to generate a circulation of the temperature control medium in the central feed channel 11 through the production cells 2 into the central discharge channel 12 back into the conveying device 5.

According to embodiments of the prior art, heat exchangers, heating elements can be arranged in this circuit for heating or cooling the temperature control medium, an admixture of cold or warm temperature control medium can be provided and/or a supply device for temperature control media can be provided for maintaining a pressure in the system. These components are not shown in the figures for reasons of clarity.

A conveying capacity of the conveying device 5 can be controlled or regulated via the central control or regulating unit 6, which can, for example, correspond to a sum of the required temperature control medium quantities and/or required temperature control medium volume flows of the individual production cells 2.

The three production cells 2 of this exemplary embodiment are each assigned a component the temperature of which needs to be controlled. These components 14 of the production cells 2 are implemented as molds 3 in this exemplary embodiment. Such molds can be, for example, injection molds. To control the temperature of these components 14, each production cell 2 has a temperature control unit 4, and the temperature control unit 4 comprises two temperature sensors 9, a flow sensor 10, and a throttle device 13 designed as a throttle valve.

The arrangement of a temperature sensor 9 in the flow direction of the temperature control medium upstream of the component 14 and of a temperature sensor 9 downstream of the component 14 as well as the flow sensor in the flow direction of the temperature control medium downstream of the component 14 allows optimal monitoring of the temperature control of the component 14, whereby a clear conclusion can be drawn about a temperature gradient, a flow rate and/or a volume flow from the signals provided to the control or regulating unit.

Through this conclusion, the control or regulating unit 6 can adjust, regulate and/or monitor the temperature control individually for each production cell 2 by controlling or regulating the throttling devices 13 on the components 14. If a change and/or alteration of an operating state of a production cell 2 occurs, this can be detected directly by the control or regulating unit 6. Such a change in the operating state can be carried out actively by the control or regulating unit 6 changing the throttle device 13 in order to optimize the temperature control of the component 14 of an associated production cell 2 and/or can be carried out passively by changing the ambient conditions in the production cell 2.

Such changes in the ambient conditions in the production cell 2 can, for example, result from an ambient temperature rising or falling, a cycle time being increased or decreased, or the absolute temperature rising or decreasing due to longer operation of the production cell 2 of the component 14.

If such a change in the operating state of a production cell 2 occurs, this directly affects the other production cells, since the opening or closing of the throttle device 13 results in a different distribution of the temperature control medium, supplied by the conveying device 5, to the remaining production cells.

However, in order to protect the other production cells from subsequent changes, the control or regulating unit 6 also intervenes directly in the other production cells via the throttling devices 13 in order to keep their temperature control as constant as possible for compensation.

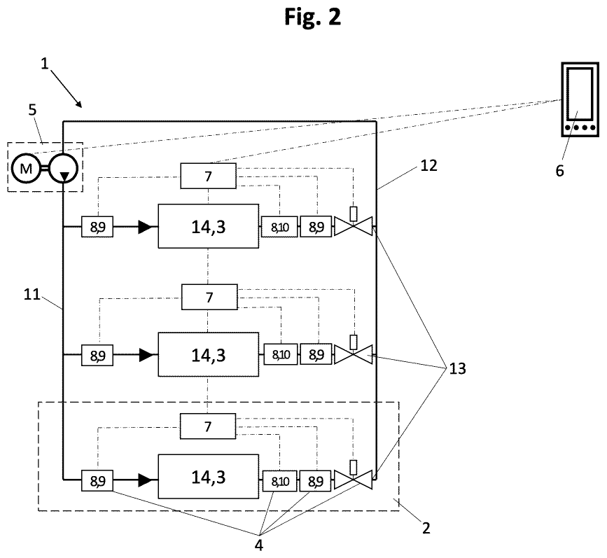

In contrast to the embodiment of FIG. 1, the embodiment of FIG. 2 of a temperature control system according to the invention shows the provision of control or regulating devices 7, which are each assigned to a temperature control device 4 of each production cell 2. These control or regulating devices 7 of the individual production cells 2 are designed to locally or individually control each temperature control device 4 of the associated production cell 2 with regard to the temperature control of the respective component 14. These control or regulating devices 7 can also be implemented, for example, by central machine controls, for example of an injection molding machine.

The control or regulating devices 7 are connected in a signal-conducting manner to the control or regulating unit 6 of the temperature control system 1, wherein the control or regulating unit 6, in short, carries out a higher-level control or regulation of the control or regulating device 7.

The control or regulating devices 7 are designed to transmit any parameters, sensor signals and operating states of the production cells 2 to the control or regulating unit 6. The control or regulating unit 6 monitors the transmitted signals and detects a variation or a change in the operating state of a production cell 2 or of the temperature control device 4 assigned to the production cell 2. When such a change or alteration of an operating state of a production cell 2 is detected, the control or regulating unit 6 outputs a control signal to the control or regulating device 7 of the other production cells 2 in order to compensate for a subsequent change.

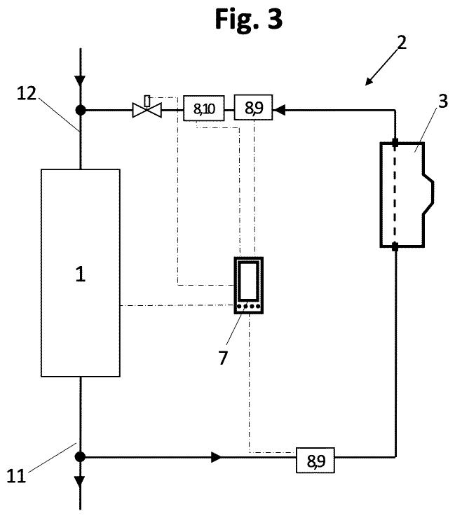

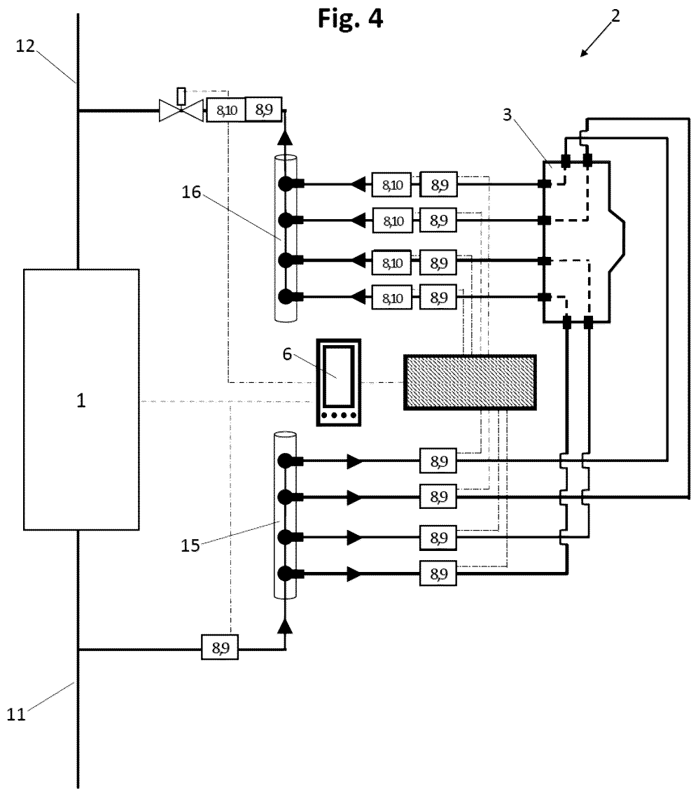

FIGS. 3 and 4 show two different exemplary embodiments of production cells 2, which can be integrated into a temperature control system 1 of the preceding embodiment variants of FIGS. 1 and 2. The exemplary embodiment of FIG. 3 of a production cell 2 comprises a mold 3 which has a temperature control channel. This temperature control channel is fed by a line branching off from the central supply channel 11 and supplied with temperature control medium. The temperature control medium flowing out of the mold 3 is in turn returned to the central discharge channel 12 of the temperature control system 1. Again, temperature sensors 9 and a flow sensor 10 are provided in the production cell 2 for process monitoring and for monitoring the operating state of the production cell 2, which transmit corresponding signals to the control or regulating device 7.

Furthermore, a throttle device 13 designed as a throttle valve is provided, which is connected to the control or regulating device 7 in a signal-conducting manner for control or regulation. The control or regulating device 7 is in turn connected to the temperature control system 1, more precisely to the control or regulating unit 6 of the temperature control system 1, in a signal-conducting manner in order to provide signals to the control or regulating unit 6 or to receive control signals from the control or regulating unit 6.

The embodiment of FIG. 4 essentially shows a similar design to FIG. 3. FIG. 4 comprises, in addition to FIG. 3, multiple-four-temperature control channels in the mold 3, wherein the temperature control device 4 comprises a temperature control media distributor 15 and a temperature control media collection line 16 in order to divide the temperature control media flow, originating from the central feed channel 11, between the four temperature control channels of the mold 3 or to collect it again via the temperature control media collector line 16.

Furthermore, for the controlled temperature control of each temperature control line of the mold 3, each of these lines comprises two temperature sensors 9 and an additional flow sensor 10. This plurality of sensor signals from the individual temperature control lines of the mold 3 can be collected centrally and transmitted to the control or regulating device 7, which in turn can transmit these signals via its signal-conducting connection to the control or regulating unit 6 of the temperature control system 1. For example, in an embodiment as shown in FIG. 4, it could also be provided that the flow sensor 10 downstream of the temperature control medium collecting line 16 is omitted, wherein this information could also be obtained, for example, by means of the control or regulating unit 6 by adding the sensor signals obtained by the flow sensors 10 arranged in the individual temperature control channels.

It is also conceivable to omit the temperature sensors 9 in the individual temperature control channels downstream of the temperature control media distributor and upstream of the mold 3, wherein sufficient information could still be provided to the control or regulating unit 6 for detecting and/or monitoring an operating state.

A design of FIG. 4 entirely without temperature sensors 9 would also be conceivable, wherein monitoring, regulation and/or control of the control or regulating unit 6 would be possible solely on the basis of the flow sensors 10.

### LIST OF REFERENCE NUMERALS

1 temperature control system
2 production cell
3 mold
4 temperature control device
5 conveying device
6 control or regulating unit
7 control or regulating device
8 sensor
9 temperature sensor
10 flow sensor
11 central feed channel
12 central discharge channel
13 throttle device
14 component
15 temperature control media distributor
16 temperature control media collector line

1. A temperature control system for controlling the temperature of components, in particular molds, of production cells, the temperature control system comprising:
at least one centrally supplyable temperature control device assigned to at least one production cell,
a central control or regulating unit, and
optionally at least one conveying device for supplying the temperature control devices with a temperature control medium,
wherein the central control or regulating unit is configured to control the respective at least one temperature control device and optionally the at least one conveying device by control commands,
wherein the central control or regulating unit is further configured to at least partially compensate for a subsequent change in operating states of the temperature control devices assigned to the other production cells caused thereby by changing the control commands when changing and/or in case of a change of an operating state of at least one production cell.

2. The temperature control system according to claim 1, wherein at least one temperature control device assigned to the production cells has a control or regulating device, which control or regulating device is connected in a signal-conducting manner to the central control or regulating unit, wherein the control or regulating device is configured to control or regulate the temperature control of the respective production cell.

3. The temperature control system according to claim 2, wherein the control or regulating unit is configured to output corresponding control commands to the at least one control or regulating device of the other production cells in the event of a change in the operating state of one of the production cells, wherein the control or regulating devices are configured to implement these control commands on the respective temperature control device.

4. The temperature control system according to claim 1, wherein at least one, preferably all, of the temperature control devices have at least one sensor, preferably connected in a signal-conducting manner to the central control or regulating unit, which sensor is configured to detect a characteristic signal for an operating state of the respective production cell.

5. The temperature control system according to claim 2, wherein the control or regulating unit is configured to detect a change in the operating state of the associated production cell and/or to monitor the operating state of the associated production cell by transmitted signals from the control or regulating device and/or the sensor.

6. The temperature control system according to claim 5, wherein the control or regulating unit is configured to change the control commands of the temperature control devices of the other production cells and/or optionally of the conveying device in the event of a change in the operating state of the associated production cell, preferably in terms of amount, greater than a predefined limit value.

7. The temperature control system according to claim 1, wherein the at least one conveying device which can be controlled by the central control or regulating unit is configured to provide a temperature control medium guided in a central supply channel for the at least one temperature control device assigned to the production cells.

8. The temperature control system according to claim 7, wherein the control or regulating unit is configured to output corresponding control commands to the at least one conveying device in the event of a change in the operating state of one of the production cells, wherein the control or regulating device is configured to adapt a conveying capacity of the at least one conveying device of the temperature control system to the change in the operating condition.

9. The temperature control system according to claim 1, wherein the at least one temperature control device assigned to the production cells is connected to at least one central supply channel and at least one central return channel of the temperature control system, wherein a temperature control medium is provided to the temperature control devices via the central supply channel and is discharged via the central discharge channel.

10. The temperature control system according to claim 1, wherein at least one, preferably all, of the at least one temperature control device assigned to the production cells has a throttle device which is connected in a signal-conducting manner to the control or regulating unit and/or the control or regulating device, which throttle device is configured to adapt a temperature control by varying a volume flow of the temperature control medium.

11. The temperature control system according to claim 10, wherein the control or regulating unit is configured to output the corresponding control commands directly or indirectly to at least one throttle device of the other production cells when the operating state of one of the production cells changes.

12. The temperature control system according to claim 1, wherein the control or regulating unit is configured to reduce a conveying capacity of the at least one conveying device and/or to reduce a volume flow of the conveying device in the event of a change in an operating state of one of the production cells, which leads to a reduced need for temperature control the associated production cell, in particular to a shutdown of the associated production cell.

13. The temperature control system according to claim 1, wherein the control or regulating unit is configured to increase a conveying capacity of the at least one conveying device and/or to increase a volume flow of the conveying device and/or to output a warning signal and/or to adapt the operating conditions of the other production cells, in particular by the control or regulating devices, in the event of a change in an operating state of one of the production cells, which leads to an increased requirement for temperature control of the associated production cell.

14. A method for operating a temperature control system for temperature control of components, preferably molds of production cells, in particular of the temperature control system according to claim 1, wherein at least one centrally supplied temperature control device assigned to at least one production cell is used, and optionally the temperature control devices are supplied with a temperature control medium by at least one conveying device, wherein, when changing or when an operating state of at least one production cell is changed, a resulting subsequent change in operating states of the temperature control devices assigned to the other production cells are at least partially compensated for by changing settings and/or control commands of the temperature control devices and optionally of the at least one conveying device.

15. A use of the temperature control system according to claim 1.

16. A computer program product, in particular suitable for carrying out the method according to claim 14, comprising commands which cause a computer executing the computer program product to control at least one temperature control device of production cells and optionally at least one conveyor device in each case by issuing control commands, wherein the commands also cause the executing computer, when changing and/or in the event of a change in an operating state of at least one production cell, to at least partially compensate for a subsequent change in operating states of the temperature control devices assigned to the other production cells caused thereby by changing the control commands.

17. A computer-readable transitory or non-transitory data carrier on which a computer program product according to claim 16 is stored.

18. A data carrier signal which contains control commands which have the function of at least partially compensating for a subsequent change in the operating states of temperature control devices assigned to operating states of other production cells when changing and/or when an operating state of at least one production cell is changed.
